(19) United States
(12) Patent Application Publication
(10) Pub. No.: US 2008/0086463 A1
(43) Pub. Date: Apr. 10, 2008

(54) LEVERAGING RELATED CONTENT OBJECTS IN A RECORDS MANAGEMENT SYSTEM

(75) Inventors: Tod DeBie, Costa Mesa, CA (US); Daniel S. Whelan, Dana Point, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: FileNet Corporation

(21) Appl. No.: 11/539,982

(22) Filed: Oct. 10, 2006

(51) Int. Cl. G06F 17/30

(52) U.S. Cl. 707/4

(57) ABSTRACT

A records management system may include a records storage system configured to store and retrieve information about records, an interface configured to communicate information about the records, and an information management system configured to declare a group of related content objects as a record that is representative of the group of related content objects and to apply at least one classification in a file plan to the declared record. The information management system may in addition or instead identify at least one classification in a file plan for a record that is being evaluated based on the way in which at least one content object in a group of content objects that are related to the evaluated record is classified in the file plan.

### BACKGROUND

1. Field

This application relates to records management systems.

2. Description of Related Art

Users must often spend considerable time entering information in a records management system that relate to content objects that may also be managed by a content management system. For example, content objects must often be declared as records. This typically requires a user to assign each content object to one or more classifications in a taxonomy of records, commonly referred to as a file plan. Inconsistencies in the assignments of related content objects can result.

A records management system also often manages the disposition of content objects. The settings for the disposition of one content object, however, can be different from those of another, even though the two are related. This can lead to inconsistencies in the disposition of related content objects and associated gaps in the information that they concern. Similar inconsistencies can result from holds that are placed on one or more related content objects.

### SUMMARY

A records management system may include a records storage system configured to store and retrieve information about records, an interface configured to communicate information about the records, and an information management system.

The information management system may be configured to declare a group of related content objects as a record that is representative of the group of related content objects and to apply at least one classification in a file plan to the declared record.

The information management system may be configured to identify at least one classification in a file plan for a record that is being evaluated based on the way in which at least one content object in a group of content objects that are related to the evaluated record is classified in the file plan; and/or to determine whether the record that is being evaluated is ready for a disposition based on a disposition criterion for at least one content object in the group of content objects that are related to the evaluated record.

The information management system may be configured to create a link between each of the group of related content objects and the declared record.

The information management system may be configured to apply the classification in the file plan to the group of related content objects by individually classifying each of the group of related content objects in accordance with the classification.

The information management system may be configured to identify the group of related content objects based on links.

The information management system may be configured to identify the group of related content objects based on similarities between them. The group of related content objects may include different versions of the same document, members of a compound document, one or more parent-child relationships, and/ or one or more peer relationships.

The group of related content objects may be limited to or may exclude those having one or more user-selected classifications in the file plan and/or one or more user-selected relationships between them.

The information management system may be configured to designate the group of related content objects that are represented by the declared record automatically and/or after seeking and obtaining user approval. The information management system may be configured to seek a single approval from the user for designating the entire group of related content objects and/or to seek a separate user approval for designating each of them.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 is a block diagram of components in a records management system.

FIG. 2 is a flow diagram of a records classification process that may be implemented by the information management system shown in FIG. 1.

FIG. 3 is a diagram illustrating content objects related by links between them.

FIG. 4 is a diagram illustrating content objects related by links between them and a compound object.

FIG. 5 is a diagram illustrating inferred relationships between content objects.

FIG. 6 is a flow diagram of a content object disposition process that may be implemented by the information management system shown in FIG. 1.

FIG. 7 illustrates a table of file plan classifications that a user has selected that may be used to control classifications.

FIG. 8 illustrates a table of content object relationships that a user has selected and that may be used to control classifications.

### DETAILED DESCRIPTION OF ILLUSTRATIVE EMBODIMENTS

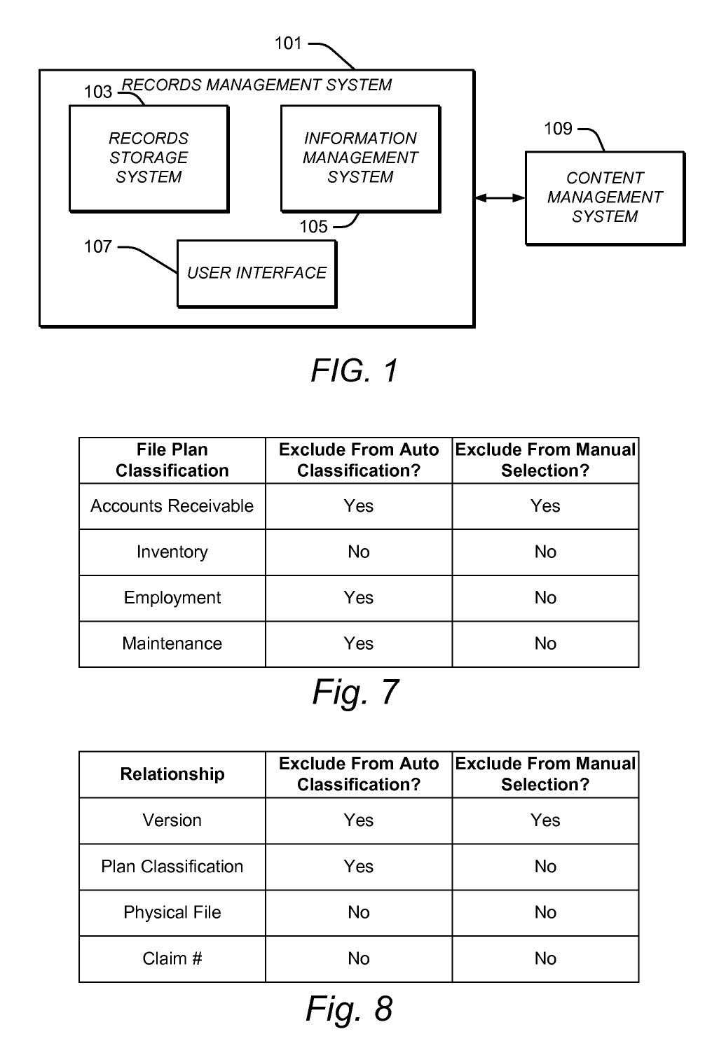

FIG. 1 is a block diagram of a records management system.

As shown in FIG. 1, a records management system 101 may include a records storage system 103, an information management system 105, and a user interface 107. The records management system 101 may include other components as well and may be communicatively connected to a content management system 109.

The user interface 107 may be configured to deliver and receive information from one or more users about records that are managed by the records management system 101. The user interface may include any type of device or devices to accomplish this purpose, including one or more keyboards, mice, joysticks, touch screens, displays, loudspeakers, and microphones.

Interfaces other than user interfaces may be used in addition or instead to deliver and/or receive information about the records. For example, information about the records, including any of the types of information described herein, may be communicated through APIs and/or Web Services.

The records storage system 103 may be configured to store and retrieve information about records that are managed by the records management system. The records storage system 103 may include any type of device or devices for accomplishing this purpose, including one or more hard drives, CD drives and CDs, DVD drives and DVDs, tape drives and tapes, flash drives, and RAMs.

The information management system 105 may be configured to manage information about records that are managed by the records management system and to communicate with the records storage system 103 and/or the user interface 107 and/or the content management system 109. The information management system 105 may include hardware, such as one or more computer processing systems, and software, such as one or more application programs, including database management programs, and operating systems.

The various components of the records management system 101 and the content management system 109 may be at a single location or may be distributed across multiple locations. One or more of these components may be linked together using any type of networking technology, such as one or more LANs, WANs, the Internet, or a combination of these. The connections may be wired, wireless, or a combination of these.

The records management system 101 and its various components may be configured to perform any records management function, including one or more of the functions that are described herein. For example, the records management system 101 and its various components may be configured to create, edit, store, retrieve and/or manage information about records.

Similarly, the content management system 109 may be configured to perform any content management function, including one or more of the functions that are described herein. For example, the content management system 109 may be configured to create, modify, store, retrieve and/or manage information about content objects.

The content objects that are managed by the content management system 109 may be any type of tangible or intangible object, such as documents. The documents may be of any type. Examples include invoices, claim forms, polices reports, and credit applications. The documents may also be in any format, including paper, negatives, and electronic files, such as files in Word, Excel, PowerPoint, CAD or PDF format.

The content management system may allow users to create and store documents and different versions of them. The content management system may also allow users to control security on a document level through an access control list. The content management system may also allow users to set retention criteria for particular documents, again at the document level. The content management system may also allow users to classify one or more documents with metadata, such as to assign titles, create dates, last modified dates, authors, and comments. The content management system may allow an administrator to customize the fields of metadata that may be stored and the security choices that ordinary users may make.

One or more of the records that are managed by the records management system 101 may have a life cycle, including an assigned time or condition for their disposition. The records management system 101 and its components may also be configured to allow a hold to be placed upon a disposition for various reasons and under various conditions.

The records management system may be configured to allow a user, such as an administrator, to establish a taxonomy for the records, such as a file plan containing a set of classifications. The classifications may have a hierarchical structure or other structure and may be reflective of folders, volumes, categories, and/or other types of segregating structures. Each classification in the file plan may be referred to as a file plan location or a file plan classification.

The particular classifications that are chosen may be based on the different types of record life cycles that are managed, including the different types of dispositions that may be used. Classifications may also be selected based on other criteria, such as security needs and reporting requirements.

The administrator may establish one or more management policies for each classification. A policy may related to anything, such as to dispositions. Disposition policies may address the timing for archiving and/or destruction.

Other policies may also be established in connection with one or more of the file plan classifications, such as policies relating to security. For example, policies may be created concerning who may see records with a particular classification and/or who may add to or change their composition. Policies may also be provided relating to other matters, such as who may delete records of a certain classification and/or when reports about them are to be provided. One or more of the policies may also specify whether approval is needed for a particular action and, if so, from whom.

The records management system 101 may be configured to allow one or more users to assign one or more records to one or more file plan classifications. This operation may be referred to as declaring a record. One or more content objects that are managed by the content management system 107 may be declared as records in the record management system 101 as part of this process. The records management system 101 may be configured to allow a single record to be classified in one or more file plan locations. A user may communicate with the records management system 101 through the user interface 107 to accomplish this purpose.

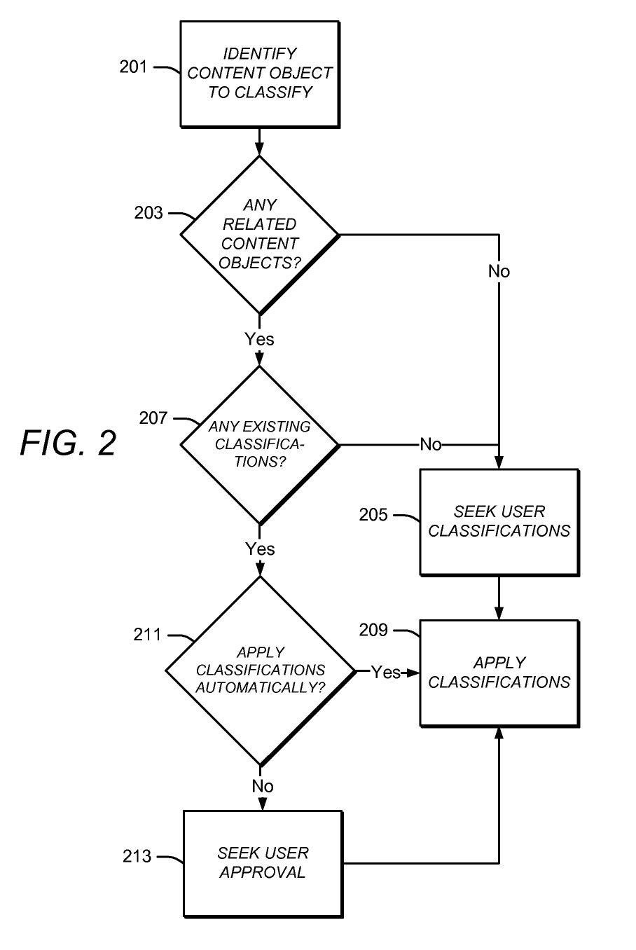

FIG. 2 is a flow diagram of a records classification process that may be implemented by the information management system 105 shown in FIG. 1. This is only an example. The information management system 105 may implement other processes, and the process shown in FIG. 2 may be implemented by other types of systems and in a different sequence than what is shown.

A content object to be classified may be identified, as reflected by an Identify Content Object to Classify step 201. This identification may come from any source. For example, a user may identify the content object through the user interface 107. The identification may instead come from another system, such as though APIs and/or Web Services. The content object may be already managed by the content management system 109 in which case the content management system 109 may be used in connection with this step.

Any type of content object may be identified. In lieu of identifying a specific content object, a compound content object may be identified that represents a group of related content objects. One example of such a compound object is discussed below in connection with FIG. 4.

A determination may be made as to whether there are any content objects known to the records management system 101 or to the content management system 109 that are related to the identified content object, as reflected by an Any Related Content Objects? decision step 203.

Any type of relationship or relationships may be considered. For example, the relationships may include hierarchical relationships, such as a parent-child relationships. Examples include the relationships between a master document and its subdocuments, between an HTML page and its components, and between a word processing document and its component parts, such as text fragments, drawings, dated and embedded objects. A single content object that incorporates or references a set of other content objects, such as the examples set forth in this paragraph, may be referred to as a compound content object.

Another type of relationship that may be considered in addition or instead is a peer-to-peer relationship. One example is the relationship between the various images on a microfilm.

Another type of relationship that may be considered in addition or instead is a subject matter relationship, such as a business relationship. All documents relating to a particular insurance claim is an example, such as the application for insurance, the insurance policy, the claim form and all invoices related to the claim. All versions of a particular document is another example, such as different editions of a document or versions of the document in different languages.

Another type of relationship that may be considered in addition or instead are physical relationships. Examples include all content objects in a particular folder, box, or on a particular tape.

Another type of relationship that may be considered in addition or instead are logical relationships. Logic relationships may include content objects that are linked, such as through OLE, P8, CS, NTFS, and/or HTTP links.

Another type of relationship that may be considered in addition or instead is a similarity in metadata about the records. All documents created on a particular date is an example.

One or more of the content objects may also have been declared separately as a record within the records management system 109.

The relationships between a group of related content objects may be express or may be inferred. Examples of these are now discussed.

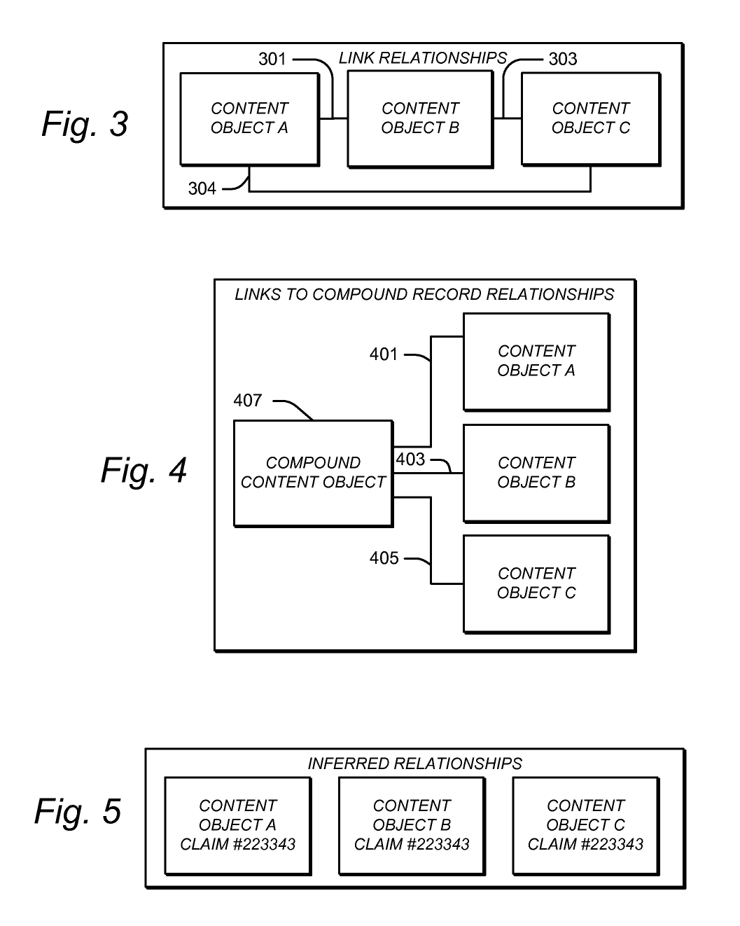

FIG. 3 is a diagram illustrating content objects related by links between them. As shown in FIG. 3, content object A, content object B, and content object C may be related by links between them, such as by links 301, 303 and 304. One or more of these links may be created manually by a user or during the process which created the content objects or which established their relationship.

FIG. 4 is a diagram illustrating content objects related by links between them and a compound content object. As shown in FIG. 4, content object A, content object B, and content object C may be related through a link 401, 403, and 405, respectively, to a compound content object 407. The compound content object 407 may be a content object that represents any group of related content objects, such as content object A, content object B, and content object C. The links between the individual content objects and the compound content object 407 may be created by a user and/or by the process that generated the records and/or established the relationships between them.

FIG. 5 is a diagram illustrating inferred relationships between content objects. The figure illustrates that relationships between content objects, such as content object A, content object B, and content object C, may be inferred, rather than through physical links. The information management system 105 may be configured to infer such relationships by virtue of any of the criteria that is indicative or record relationships. For example, and as illustrated in FIG. 5, the information management system 105 may be configured to identify all content objects bearing the same claim number as related content objects. As part of the process of identifying related content objects, the information management system 105 may be configured to seek user approval before acting upon any perceived relationship, either on a global or individual basis.

Once having identified an inferred relationship, the information management system 105 may be configured to establish physical links between each of the related content objects, such as in the form shown in FIG. 3 or FIG. 4.

The information management system 105 may be configured to create a compound content object representative of the inferred group of related content objects and to establish the links between the compound content object and the group of related content objects. Again, this may be done with or without user approval and, when with user approval, on either an individual or global basis.

If the information management system 105 fails to find any related content objects during the Any Related Content Objects? decision step 203, such as by examining direct links and/or inferred relationships, the information management system 105 may be configured to ask the user for one or more classifications for the identified content object by communicating with the user through the user interface 107, as reflected by a Seek User Classifications step 205. During this step, the user may be permitted to enter one or more user classifications for the identified content object.

On the other hand, if one or more related content objects are uncovered, the information management system 105 may be configured to determine whether any of the related content objects are already classified in the file plan, as reflected by an Any Existing Classifications? decision step 207. If not, the information management system 105 may be configured to seek one or more user classifications, as reflected by the Seek User Classifications step 205. During this step, the user may be permitted to enter one or more user classifications for the identified record.

During the Any Existing Classifications? decision step 207, the information management system 105 may learn that one or more content objects in the group of content objects have already been classified in the file plan. In this event, the information management system 105 may be configured to check whether it has been set to apply any or all of such existing classifications automatically to the selected content object or to seek user approval first, as reflected by an Apply Classifications Automatically? decision step 211.

The information management system 105 may be configured to consider any criteria in deciding whether to apply one or more of the existing classifications automatically. For example, it may consider the number of different existing classifications that it uncovers during the step 207. For example, the information management system 105 may be configured to automatically apply an existing classification only when no member of the group of related content objects is assigned to any other classification.

The information management system 105 may be configured to evaluate whether all of the related content objects uncovered during the Any Related Content Objects decision step 203 have been assigned to an existing classification. It may be configured to only automatically apply those existing classifications to which all of the related records have been assigned.

The information management system 105 may be configured to apply any combination of these logical tests, as well as any other criteria, in making the automatic classification determination that is the subject of the decision step 211.

If the information management system 105 determines that user approval for one or more classifications is required, it may seek that user approval, as reflected by a Seek User Approval step 213. During this step, the user may be permitted to approve of one or more proposed classifications, either as a batch or on an individual basis. The user may also be permitted to add classifications.

The classifications that have been selected by the user and/or determined to be automatically applied may then be applied, as reflected by an Apply Classifications step 209. The actual applications that are made may vary depending upon what proceeded this step and the configuration of the system.

If the information management system 105 had failed to identify a group of related content objects during the Any Related Content Objects? decision step 203, the classifications to be applied may be applied to only the content object that was identified during the Identify Content Object to Classify step 201.

If related content objects were identified during the decision step 203, the Apply Classification step 209 may apply one or all of the determined classifications to the content object identified during the Identify Content Object to Classify step 201 and to some or all of the related content objects. Applying the determined classification to the entire set of related content objects may obviate the need for the user to individually classify each of the group of related content objects in the records management system 101.

If the content object that was identified in the Identify Content Object to Classify step 201 was a compound content object, the information management system 105 may be configured to apply each determined classification to just the compound content object. Since the compound content object may already be linked to the group of related content objects that are identified by the compound content object, the application of the classifications to just the compound object may be sufficient to have the classifications effectively applied to the entire group of related content objects.

If the content object that was identified in the Identify Content Object to Classify step 201 was not a compound content object, but related content objects were identified during the decision step 203, the records management system 101 may create a new compound record that is representative of all of the related content objects and apply the selected file plan classification to this new compound record. The records management system may also record as part of the compound record appropriate pointers and/or other types of information that will allow the records management system 101 to later identify the set of related content objects that are represented by the newly declared compound record.

The process that is illustrated in FIG. 2 and that has been described above may effectively leverage relationships between content objects.

One way is to leverage existing classifications of content objects that are related to a new content object to be classified. If the content object to be classified is related to other content objects that have already been classified, the existing classifications of the already classified content objects may be used to quickly classify the new content object, thus relieving the user of the burden of having to select the proper classifications from a large set of possible classifications. The information management system 105 may also be configured to apply these existing classifications in an automated mode, thus further reducing the time the user must spent as part of the process. Conversely, the information management system 105 may be configured to seek user approval for all or portions of the proposed classifications, thus ensuring that the proposed classifications are warranted. Even when operating in this user-approval mode, time is still saved by having proposed classifications presented to the user that are likely to be correct.

The process shown in FIG. 2 and described above may also leverage the relationships between content objects in a second way. Rather than having a user classify each content object in a group of related content objects individually, the information management system 105 may be configured to apply a single classification decision that a user may make to an entire group of related content objects in a batch operation. As explained above, this may be made in a fully automated mode, thus maximizing the speed of the process, or user approval may similarly be sought, either for the entire batch operation or for individual parts of it. Even when user approval is sought, however, time may still be saved because the user is freed of the responsibility of having to manually identify the related records.

The processes that have been described may also enhance the uniformity of classification assignments for a related group of content objects, thus reducing inconsistencies in the management of related record information.

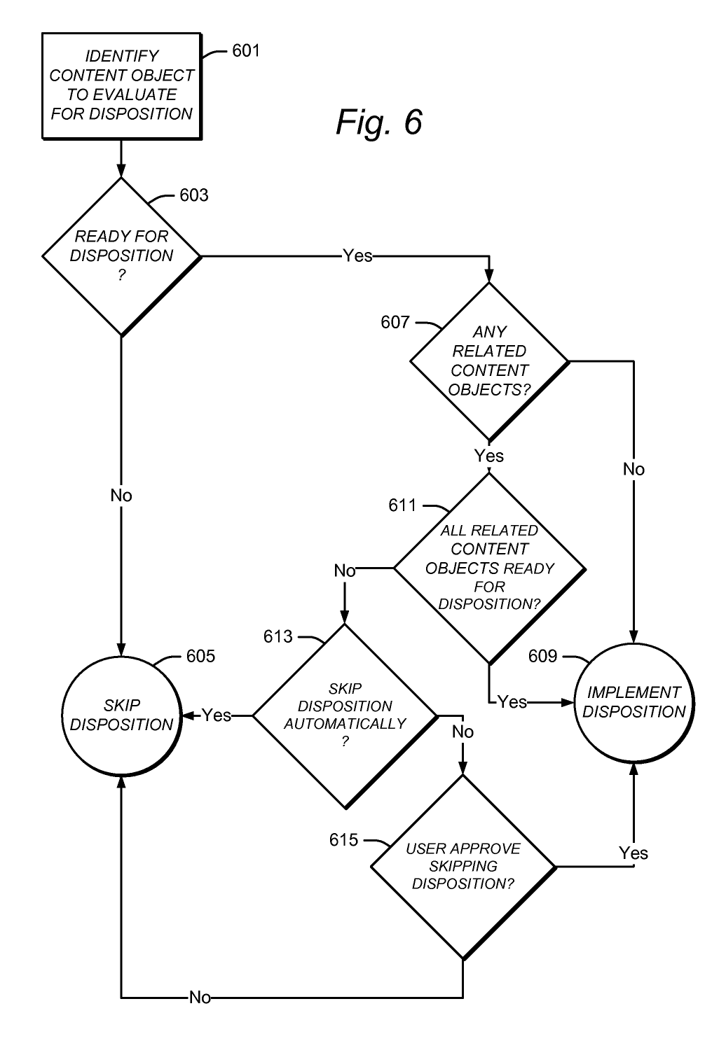

FIG. 6 is a flow diagram of a content object disposition process that may be implemented by the information management system 105 shown in FIG. 1. It is only an example. The information management system 105 may implement other disposition processes, and the disposition process shown in FIG. 6 may be implemented by other types of systems and in a different sequence than what is shown.

As shown in FIG. 6, a content object to be evaluated for a particular disposition, such as archiving or destruction, may be identified, as reflected by an Identify Content Objects To Evaluate For Disposition step 601. The content object may be identified by the information management system 105 based on information stored about the content object in the record storage system 103, such as disposition criteria. In this situation, the content object may not actually be stored within the records management system, but only a pointer to it. The content object may instead be manually identified by a user or it may be identified through other means. The content object may be an individual content object or a compound content object or record.

A determination may be made as to whether the identified content object is ready for a particular disposition, as reflected by a Ready For Disposition? decision step 603. If not, the process may skip a disposition, as reflected by a Skip Disposition step 605.

There may be certain circumstances in which the identified content object is already known to be ready for a disposition, such as when the content object is identified by the information management system 105 based on disposition criteria in the records storage system 103. In this instance, the Ready For Disposition? decision step 603 may be eliminated, as the information management system 105 may already have determined that the content object is ready for the disposition.

If the content object is ready for the disposition, a determination may be made as to whether there are any content objects related to it, as reflected by an Any Related Content Objects? decision step 607. The types of relationships that may be considered and the approaches for considering them may be any of those types and approaches that are discussed above in connection with the Any Related Content Objects? decision step 203 shown in FIG. 2.

If there are no related content objects, the identified content object may be disposed in accordance with its disposition criteria, as reflected by an Implement Disposition step 609. On the other hand, if there are related content objects, the information management system 105 may be configured to determine whether all of the related content objects are also ready for the disposition, as reflected by an All Related Content Objects Ready For Disposition? decision step 611. A hold that has been placed on one or more of the related content objects may be considered as part of this process. If all of the related content objects are also ready for the disposition, the identified record may be disposed in accordance with the disposition, as reflected by the Implement Disposition step 609.

If all of the related content objects are not ready for disposition, the information management system 105 may be configured to determine whether it has been set to skip the disposition without seeking user approval, as reflected by a Skip Disposition Automatically? decision step 613. If it has been so set, the disposition may be skipped, as reflected by the Skip Disposition step 605. Otherwise, the information management system 105 may be configured to seek approval from the user for skipping the disposition, as reflected by a User Approve Skipping Disposition? decision step 615. During this step, the information management system 105 may be configured to present an analysis to the user through the user interface 107 of the disposition criteria and/or status of the related records so that the user can decide whether to stop or to go ahead with the disposition of the identified record.

The net effect of this process may be to ensure that a particular content object is not disposed until all other content objects that are related to it are also ready for the disposition.

The information management system may be configured to control one or more operations during the processes discussed above based on selections made by a user of one or more file plan classifications and/or record relationships before the process take place.

For example, a user may be allowed to select one or more file plan classifications and/or content object relationships that cause a content object having one of these selected classifications or relationships to be excluded from being deemed a related content object during the Any Related Content Objects? decision step 203 and/or 607. The user may instead be allowed to select the file plan classifications and/or content object relationships that a content object must have in order to be deemed a related content object during one of these steps.

The user in addition or instead may be allowed to specify how one or more file plan classifications are to be handled during the Apply Classifications Automatically? decision step 211. For example, the user may be allowed to specify which existing file plan classifications will automatically be applied, which will be applied only after seeking and receiving user approval, and which will never be applied. Examples of such settings are shown in FIG. 7. FIG. 7 illustrates a table of file plan classifications that a user has selected and that may be used to control classifications.

Similar options may be provided in connection with content object relationships which the user may be allowed to select in advance. An example of such selections is shown in FIG. 8. FIG. 8 illustrates a table of content object relationships that a user has selected and that may be used to control classifications.

Advanced user selections of file plan classifications and/or content object relationships may similarly be used to regulate the Skip Disposition Automatically? decision step 613. For example, the user may be able to specify which file plan classifications will cause a disposition to be automatically stopped, which will cause the disposition to be stopped only after user approval, and which will never cause the disposition to be stopped. Similar options may be provided in connection with record relationships which the user may similarly be allowed to select in advance.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently. In short, the scope of protection is limited solely by the claims that now follow. That scope is intended to be as broad as is reasonably consistent with the language that is used in the claims and to encompass all structural and functional equivalents.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

Nothing that has been stated or illustrated is intended to cause a dedication of any component, step, feature, object, benefit, advantage, or equivalent to the public, regardless of whether it is recited in the claims.

We claim:

1. A records management system comprising:
a records storage system configured to store and retrieve information about records;
an interface configured to communicate information about the records; and
an information management system configured to declare a group of related content objects as a record that is representative of the group of related content objects and to apply at least one classification in a file plan to the declared record.

2. The records management system of claim 1 wherein the group of related content objects are also classified in the file plan and the classification of the declared record is based on the way in which at least one of the group of related content objects is classified in the file plan.

3. The records management system of claim 1 wherein the information management system is also configured to determine whether a content object in the group of related content objects is ready for a disposition based on a disposition criterion of at least one other content object in the group of related content objects.

4. The records management system of claim 1 wherein the information management system is also configured to create a link between each of the group of related content objects and the declared record.

5. The records management system of claim 2 wherein the information management system is also configured to individually apply the classification in the file plan to each of the group of related content objects.

6. The records management system of claim 1 wherein the information management system is also configured to identify the group of related content objects based on links.

7. The records management system of claim 1 wherein the information management system is also configured to identify the group of related content objects based on similarities between them.

8. The records management system of claim 1 wherein the group of related content objects includes different versions of the same document.

9. The records management system of claim 1 wherein the group of related content objects includes members of a compound document.

10. The records management system of claim 1 wherein the group of related content objects have one or more parent-child relationships.

11. The records management system of claim 1 wherein the group of related content objects have one or more peer relationships.

12. The records management system of claim 1 wherein the group of related content objects are limited to those having one or more user-selected classifications in the file plan.

13. The records management system of claim 1 wherein the group of related content objects exclude those having one or more user-selected classifications in the file plan.

14. The records management system of claim 1 wherein the group of related content objects are limited to those having one or more user-selected relationships between them.

15. The records management system of claim 1 wherein the group of related content objects exclude those having one or more user-selected relationships between them.

16. The records management system of claim 1 wherein the information management system is also configured to designate the group of related content objects that are represented by the declared record automatically.

17. The records management system of claim 1 wherein the information management system is also configured to designate the group of related content objects that are represented by the declared record after seeking and obtaining user approval.

18. The records management system of claim 17 wherein the information management system is also configured to seek a single approval from the user for designating the entire group of related content objects to be represented by the declared record.

19. The records management system of claim 17 wherein the information management system is also configured to seek a separate user approval for designating each of the group of related content objects to be represented by the declared record.

20. The records management system of claim 1 further comprising a content management system configured to store and retrieve information about the group of related content objects.

21. A records management process comprising:
storing and retrieving information about records;
communicating information about the records; and
declaring a group of relate content objects as a record that is representative of the group of related content objects and applying at least one classification in a file plan to the declared record.

22. A records management system comprising:
a records storage system configured to store and retrieve information about records;
an interface configured to communicate information about the records; and
an information management system configured to identify at least one classification in a file plan for a record that is being evaluated based on the way in which at least one content object in a group of content objects that are related to the evaluated record is classified in the file plan.

23. The records management system of claim 22 wherein the information management system is also configured to determine whether a content object in the group of related content objects is ready for a disposition based on a disposition criterion of at least one content objects in the group of related content objects.

24. The records management system of claim 22 wherein the information management system is also configured to apply the classification to the evaluated record.

25. The records management system of claim 24 wherein the information management system is also configured to apply the classification to the evaluated record automatically.

26. The records management system of claim 24 wherein the information management system is also configured to apply the classification to the evaluated record after seeking and obtaining user approval.

27. The records management system of claim 22 wherein the information management system is also configured to identify the group of related content objects based on links.

28. The records management system of claim 22 wherein the information management system is also configured to identify the group of related content objects based on similarities between them.

29. The records management system of claim 22 wherein the group of related content objects includes different versions of the same document.

30. The records management system of claim 22 wherein the group of related content objects includes members of a compound document.

31. The records management system of claim 22 wherein the group of related content objects have one or more parent-child relationships.

32. The records management system of claim 22 wherein the group of related content objects have one or more peer relationships.

33. The records management system of claim 22 wherein the group of related content objects are limited to those having one or more one or more user-selected classifications in the file plan.

34. The records management system of claim 22 wherein the group of related content objects exclude those having one or more user-selected classifications in the file plan.

35. The records management system of claim 22 wherein the group of related content objects are limited to those having one or more user-selected relationships between them.

36. The records management system of claim 22 wherein the group of related content objects exclude those having one or more user-selected relationships between them.

37. The records management system of claim 22 further comprising a content management system configured to store and retrieve information about the group of related content objects.

38. A records management process comprising:
storing and retrieving information about records;
communicating information about the records; and
identifying at least one classification in a file plan for a record that is being evaluated based on the way in which at least one content object in a group of content objects that are related to the evaluated record is classified in the file plan.

39. A records management system comprising:
a records storage system configured to store and retrieve information about records;
an interface configured to communicate about the records; and
an information management system configured to determine whether a record that is being evaluated is ready for a disposition based on a disposition criterion for at least one content object in a group of content objects that are related to the evaluated record.

40. The records management system of claim 39 wherein the information management system is also configured to determine that the evaluated record is not ready for the disposition if the disposition criterion indicates that at least one of the content objects in the group of related content objects is not ready for the disposition.

41. The records management system of claim 40 wherein:
the disposition criterion includes hold criterion; and
the records management system is also configured to determine that the evaluated record is not ready for the disposition if the hold criterion indicates that at least one of the content objects in the group of related content objects is still on hold.

42. The records management system of claim 39 wherein the information management system is also configured to base the determination of whether the evaluated record is ready for the disposition on the disposition criterion of a compound record that is representative of the group of content objects.

43. The records management system of claim 42 wherein the information management system is also configured to create a link between each of the group of related content objects and the compound record.

44. The records management system of claim 39 wherein the information management system is also configured to identify the group of related content objects based on links.

45. The records management system of claim 39 wherein the information management system is also configured to identify the group of related content objects based on similarities between them.

46. The records management system of claim 39 wherein the group of related content objects includes different versions of the same document.

47. The records management system of claim 39 wherein the group of related content objects includes members of a compound document.

48. The records management system of claim 39 wherein the group of related content objects have one or more parent-child relationships.

49. The records management system of claim 39 wherein the group of related content objects have one or more peer relationships.

50. The records management system of claim 39 wherein the group of related content objects are limited to those having one or more user-selected classifications in a file plan.

51. The records management system of claim 39 wherein the group of related content objects exclude those having one or more user-selected classifications in a file plan.

52. The records management system of claim 39 wherein the group of related content objects are limited to those having one or more user-selected relationships between them.

53. The records management system of claim 39 wherein the group of related content objects exclude those having one or more user-selected relationships between them.

54. The records management system of claim 39 further comprising a content management system configured to store and retrieve information about the group of related content objects

55. A records management process comprising:
storing and retrieving information about records;
communicating about the records; and
determining whether a record that is being evaluated is ready for a disposition based on a disposition criterion for at least one content object in a group of content objects that are related to the evaluated record.
